(19) United States
(12) Patent Application Publication
(10) Pub. No.: US 2018/0281933 A1
(43) Pub. Date: Oct. 4, 2018

(54) Double Folding Drone Arms with Landing Gear

(71) Applicant: QUALCOMM Incorporated, San Diego, CA (US)

(72) Inventors: Jonathan Paul Davis, Philadelphia, PA (US); Donald Hutson, San Diego, CA (US); Paul Ferrell, San Diego, CA (US); Clayton Dumstorff, San Diego, CA (US); Travis Van Schoyck, Lafayette Hill, PA (US); Ross Eric Kessler, Philadelphia, PA (US)

(21) Appl. No.: 15/651,212

(22) Filed: Jul. 17, 2017

Related U.S. Application Data
(60) Provisional application No. 62/479,672, filed on Mar. 31, 2017.

(51) Int. Cl. B64C 25/12; B64C 25/04; B64C 27/37; B64C 39/02

(52) U.S. Cl. CPC B64C 25/12; B64C 25/04; B64C 27/37; B64C 2025/125; B64C 2201/088; B64C 2201/108; B64C 2201/165; B64C 39/024

(57) ABSTRACT

Methods, devices, and systems of various embodiments are disclosed for operating a propeller assembly for use with a UAV. Various embodiments include a propeller assembly including a pivotal arm, a propeller mounted on the pivotal arm, and pivotal leg coupled to the pivotal arm. The pivotal leg may be folded into the pivotal arm and the pivotal arm may be folded into a body of the UAV. A processor may be coupled to the propeller assembly and configured with processor-executable instructions to perform operations of the propeller assembly.

### RELATED APPLICATIONS

This application claims the benefit of priority to U.S. Provisional Patent Application No. 62/479,672 entitled “Double Folding Drone Arms with Landing Gear” filed Mar. 31, 2017, the entire contents of which are hereby incorporated by reference in their entirety.

### BACKGROUND

Unmanned aerial vehicles (UAVs), also referred to as “drones,” are commonly used for delivery, surveying, photography, and/or power or communications repeater functions. Some UAVs include booms that fold into the body of the drone to be compact and transportable. Some UAVs also have short landing gear such that the UAVs rest very close to the ground. Longer landing gear would otherwise protrude out of the bottom of the drone when compacted and decrease the drone's compactness. However, short landing gear may limit the functionality of a UAV and/or algorithms operated by the UAV.

### SUMMARY

Various embodiments include a propeller assembly for use on a drone having a pivotal arm extending from the drone, a propeller mounted on or near the distal end of the pivotal arm, and a pivotal leg extending from the pivotal arm. In some embodiments, the pivotal arm may be hollow with the hollow portion exposed on at least one side of the pivotal arm and the pivotal leg may be coupled to the pivotal arm such that the pivotal leg may be foldable into the exposed hollow portion of the pivotal arm. In some embodiments, the pivotal leg may be hollow with the hollow portion exposed on at least one side of the pivotal leg and the pivotal leg may be coupled to the pivotal arm such that the pivotal arm rests within the exposed hollow portion of the pivotal leg when the pivotal leg is folded onto the pivotal arm. In some embodiments, the pivotal arm may be hollow with an opening at the distal end of the pivotal arm and the pivotal leg may be coupled to the pivotal arm such that the pivotal leg may be retractable into the hollow portion of the pivotal arm via the opening at the distal end of the pivotal arm. In some embodiments, the pivotal arm may be foldable towards a body of the drone. In some embodiments, the pivotal leg may be foldable away from the body of the drone. In some embodiments, the pivotal leg may be coupled to the distal end of the pivotal arm.

Some embodiments include a method of operating a propeller assembly of a drone including extending a pivotal arm from a body of the drone and extending a pivotal leg from the pivotal arm. In some embodiments, the pivotal arm may be hollow with the hollow portion exposed on at least one side of the pivotal arm, the pivotal leg may be coupled to the pivotal arm such that the pivotal leg may be foldable into the exposed hollow portion of the pivotal arm, and the method may further include folding the pivotal leg into the exposed hollow portion of the pivotal arm and folding the pivotal arm towards the body of the drone. In some embodiments, the pivotal leg may be hollow with the hollow portion exposed on at least one side of the pivotal leg, the pivotal leg may be coupled to the pivotal arm such that the pivotal arm rests within the exposed hollow portion of the pivotal leg when the pivotal leg is folded onto the pivotal arm, and the method may further include folding the pivotal leg onto the pivotal arm and folding the pivotal arm towards the body of the drone. In some embodiments, the pivotal arm may be hollow with an opening at the distal end of the pivotal arm, the pivotal leg may be coupled to the pivotal arm such that the pivotal leg may be retractable into the hollow portion of the pivotal arm via the opening at the distal end of the pivotal arm, and the method may further include retracting the pivotal leg into the pivotal arm and folding the pivotal arm towards the body of the drone.

Further embodiments may include a propeller assembly for use on a drone having means for performing functions of the method summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1A is a perspective view of a propeller assembly for use with a drone with a pivotal arm, a propeller mounted on the pivotal arm, and a pivotal leg according to various embodiments.

FIG. 1B is a side elevation view of the propeller assembly in FIG. 1A according to various embodiments.

FIG. 1C is a side elevation view of the propeller assembly in FIG. 1A according to various embodiments.

FIG. 1D is a side elevation view of the propeller assembly in FIG. 1A according to various embodiments.

FIG. 2A is a perspective view of the propeller assembly in FIG. 1A mounted to a drone according to various embodiments.

FIG. 2B is a side elevation view of the propeller assembly mounted to the drone in FIG. 2A according to various embodiments.

FIG. 3 is a component diagram of a control unit of a UAV suitable for use with various embodiments.

FIG. 4 is a process flow diagram illustrating a method of operating a propeller assembly according to various embodiments.

FIG. 5 is a process flow diagram illustrating a method of operating a propeller assembly according to various embodiments.

FIG. 6 is a component diagram of a wireless communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include a propeller assembly for use with a UAV. The propeller assembly includes a pivotal arm that may be foldable, a propeller mounted on the pivotal arm, and a pivotal leg that may be foldable. The propeller assembly may also include a motor or other actuation device configured to control movement of arm and/or leg. The UAV may include a processor coupled to the propeller assembly and configured with processor-executable instructions to control operations of extending the pivotal leg and extending the pivotal arm. The processor may also be configured with processor-executable instructions to control operations of retracting or otherwise folding the pivotal leg and retracting or otherwise folding the pivotal arm.

As used herein, the term “UAV” refers to one of various types of unmanned aerial vehicle. A UAV may include an onboard computing device configured to fly and/or operate the UAV without remote operating instructions (i.e., autonomously), such as from a human operator or remote computing device. Alternatively, the onboard computing device may be configured to fly and/or operate the UAV with some remote operating instruction or updates to instructions stored in a memory of the onboard computing device. The UAV may be propelled for flight in any of a number of known ways. For example, a plurality of propulsion units, each including one or more rotors, may provide propulsion or lifting forces for the UAV and any payload carried by the UAV. The UAV may be powered by one or more types of power source, such as electrical, chemical, electro-chemical, or other power reserve, which may power the propulsion units, the onboard computing device, and/or other onboard components.

The term “computing device” is used herein to refer to an electronic device equipped with at least a processor. Examples of computing devices may include UAV flight control and/or mission management computer onboard the UAV, as well as remote computing devices communicating with the UAV configured to perform operations of the various embodiments. Remote computing devices may include wireless communication devices (e.g., cellular telephones, wearable devices, smartphones, web-pads, tablet computers, Internet enabled cellular telephones, Wi-Fi® enabled electronic devices, personal data assistants (PDA's), laptop computers, etc.), personal computers, and servers. In various embodiments, computing devices may be configured with memory and/or storage as well as wireless communication capabilities, such as network transceiver(s) and antenna(s) configured to establish a wide area network (WAN) connection (e.g., a cellular network connection, etc.) and/or a local area network (LAN) connection (e.g., a wireless connection to the Internet via a Wi-Fi® router, etc.).

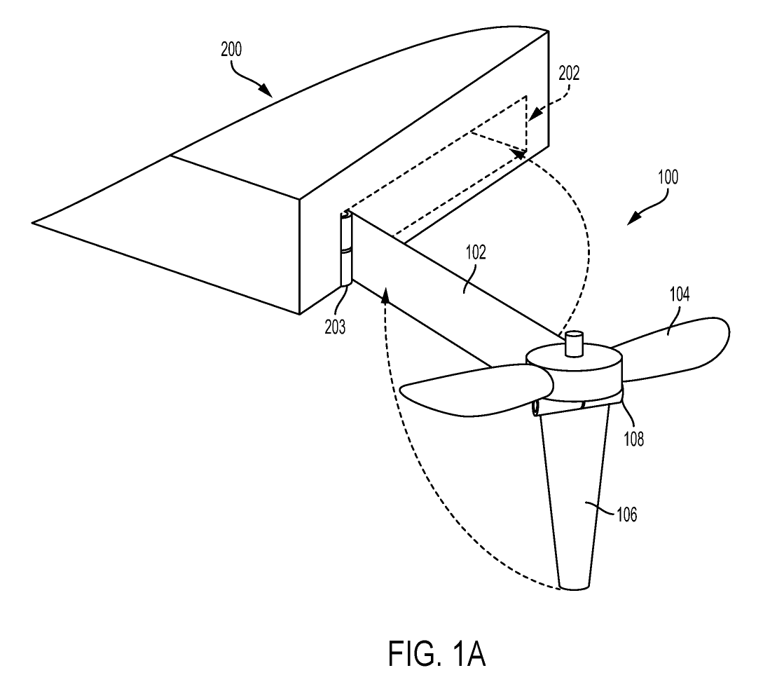

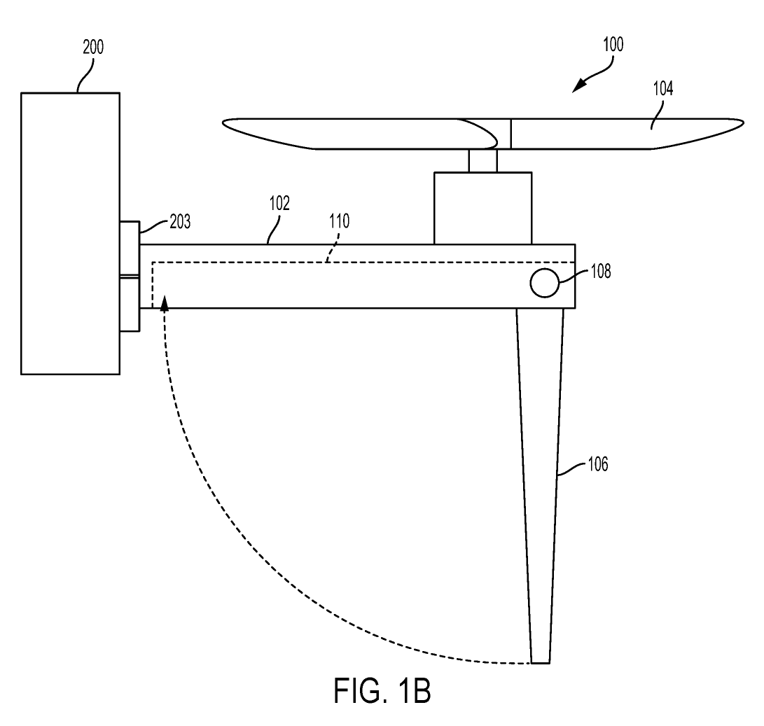

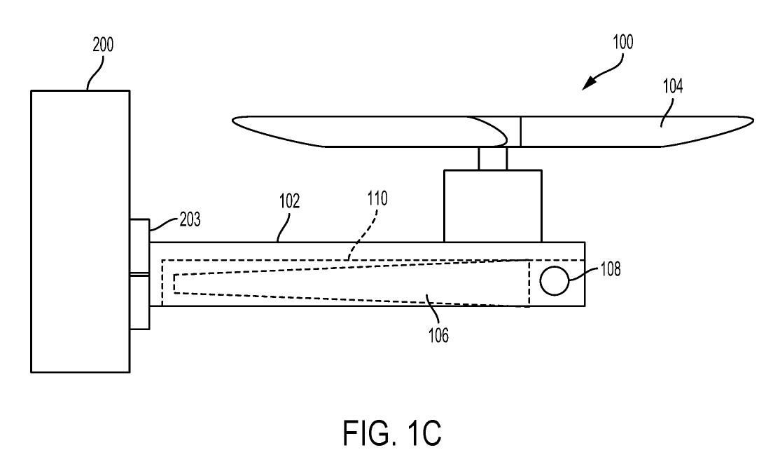

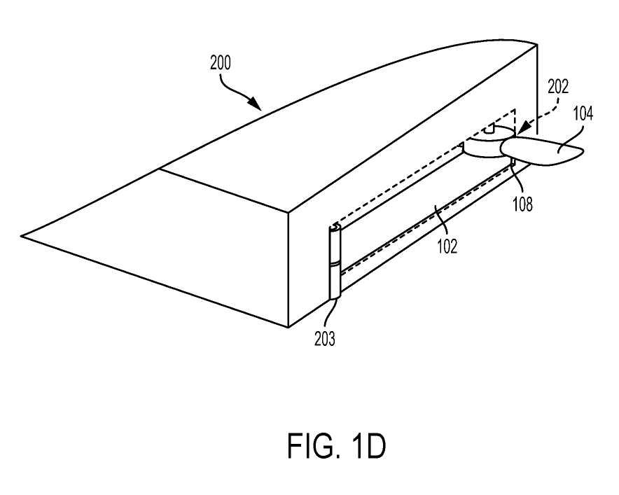

FIGS. 1A-1D illustrate a propeller assembly 100 with a pivotal arm 102 pivotally coupled by a hinge 203 to a UAV 200 in accordance with some embodiments. The propeller assembly 100 may include a propeller 104 mounted on the pivotal arm 102 and a pivotal leg 106 pivotally coupled to the pivotal arm 102. With reference to FIGS. 1A-1D, when the propeller assembly 100 is fully extended, the pivotal leg 106 may serve as landing gear for the UAV 200. Although only a single propeller assembly 100 is illustrated, multiple propeller assemblies 100 may be attached to a single UAV 200.

For ease of description and illustration, some detailed aspects of the propeller assembly 100 are omitted, such as wiring, frame structure interconnects, drive assemblies, lever arms, or other features that would be known to one of skill in the art. For example, while the propeller assembly 100 is shown and described as having a hinge 108 connecting the pivotal leg 106 to the pivotal arm 102, the propeller assembly 100 may be assembled utilizing other structures for connecting the pivotal leg 106 to the pivotal arm 102.

As illustrated, the pivotal leg 106 may extend from the pivotal arm 102 and the pivotal leg 106 may fold towards the pivotal arm 102. Although FIGS. 1A and 1D illustrate the pivotal leg 106 extended perpendicularly from the pivotal arm 102, this is only for simplicity. In various embodiments, the pivotal leg 106 may be extended at any one or various angles relative to the pivotal arm 102 so that, when extended, the propeller assembly 100 may function as landing gear for the UAV 200.

In various embodiments, the pivotal arm 102 may include a hollow portion 110 or otherwise include an open volume into which at least a portion of the pivotal leg 106 may be folded as illustrated in FIGS. 1B and 1C. Alternatively, the pivotal leg 106 may be at least partially hollow or otherwise include an open volume configured so that the pivotal leg 106 encompasses at least a portion of the pivotal arm 102 when the pivotal leg 106 is folded onto the pivotal arm 102. In some embodiments, the pivotal arm 102 may include a hollow portion 110 with an opening at a distal end and the pivotal leg 106 may be coupled or otherwise coupled to the pivotal arm 102 in such a way that the pivotal leg 106 may be retractable into the hollow portion 110 of the pivotal arm 102 via the opening in the distal end of the pivotal arm 102. In some embodiments, the pivotal leg 106 may be folded towards the pivotal arm 102 in such a manner that the pivotal leg 106 rests against or otherwise parallel to the pivotal arm 102.

The pivotal arm 102 may extend from the UAV 200 and may fold about a hinge 203 towards the UAV 200. Although FIGS. 1A and 1D show the pivotal arm 102 extended at a right angle from the UAV 200, this is only for simplicity. In various embodiments, the pivotal arm 102 may be extended at any one or various angles relative to the UAV 200 so that, when the pivotal leg 106 is extended from the pivotal arm 102 of the propeller assembly 100, pivotal leg 106 may function as landing gear for the UAV 200. In various embodiments, the UAV 200 may include a hollow portion 202 or other open volume into which at least a portion of the pivotal arm 102 may be folded as illustrated in FIG. 1D. Thus, the propeller assembly 100 may be stored at least partially within the UAV 200.

In various embodiments, the pivotal leg 106 may be coupled to the pivotal arm 102 via a hinge 108 or equivalent structure that enables the pivotal leg 106 to rotate with respect to the pivotal arm 102. Alternatively, the pivotal leg 106 may be coupled to the pivotal arm 102 via one or more pins or any other mechanism for connecting two pivotal members. In some embodiments, the pivotal leg 106 and the pivotal arm 102 may be operated manually to extend or fold the pivotal leg 106 and/or the pivotal arm 102. In some embodiments, the hinge 108 or equivalent structure may be mechanized by an actuator or motor so that the extending and/or folding operations may be controlled via a processor of the UAV 200 or an external computing device. In some embodiments, the hinge 108 or equivalent structure may include a lever, actuator or other mechanism (not shown) configured to deploy the pivotal leg 106 as the pivotal arm 102 is rotated.

In some embodiments, the pivotal leg 106 may be coupled to the pivotal arm 102 at or near a distal end of the pivotal arm 102. In such embodiments, the pivotal leg 106 may pivot towards the UAV 200 when folding against the pivotal arm 102. In some embodiments, the pivotal leg 106 may be coupled to the pivotal arm 102 at or near a proximal end of the pivotal arm 102 or at a location between the proximal end and the distal end of the pivot arm 102. In such embodiments, the pivotal leg 106 may pivot away from the UAV 200 when folding against the pivotal arm 102. In some embodiments, the pivotal leg 106 may be significantly shorter than the pivotal arm 102, and the pivotal leg 106 may be coupled to the pivotal arm 102 at a location along the pivotal arm 102 so that the pivotal leg 106 may be foldable into, parallel to, or otherwise onto the pivotal arm 102.

In some embodiments, the pivotal leg 106 may be at least long enough such that a UAV 200 with the one or more cameras attached underneath have a ground clearance of at least an inch and a half (1.5″) when the propeller assembly 100 is fully deployed and the pivotal leg 106 is resting on the ground. In some embodiments, the pivotal leg 106 may be sized so that when the propeller assembly 100 is fully deployed and resting on the ground, a camera attached to the UAV 200 has a ground clearance.

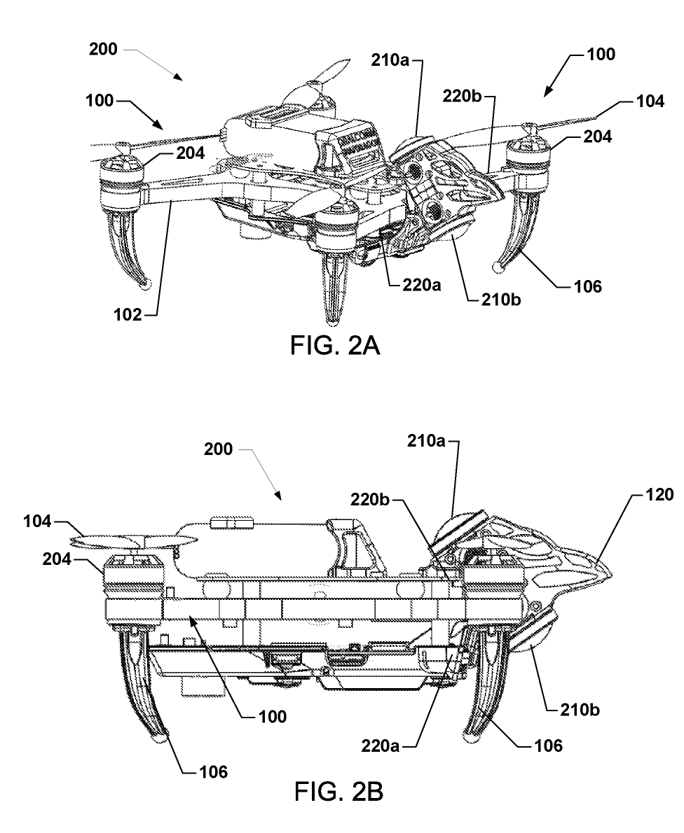

FIGS. 2A and 2B are perspective and side views, respectively, of the propeller assembly 100 mounted to an example drone 200. With reference to FIGS. 1A-2B, the pivotal arm 102 may be pivotally coupled or otherwise affixed to the drone 200 at one or more brackets or similar mounting points 220a, 220b. In some embodiments, the pivotal arm 102 may be connected to mounting points 220a, 220b directly on the body of the drone 200. In various embodiments, the pivotal arm 102 may couple the propeller assembly 100 to the drone 200 in different mounting points 220a and 220b based on different drone parameters (e.g., size, shape, etc.) of the drone 200.

A camera apparatus 120 may be coupled to the drone 100 including one or more cameras 210a, 210b.

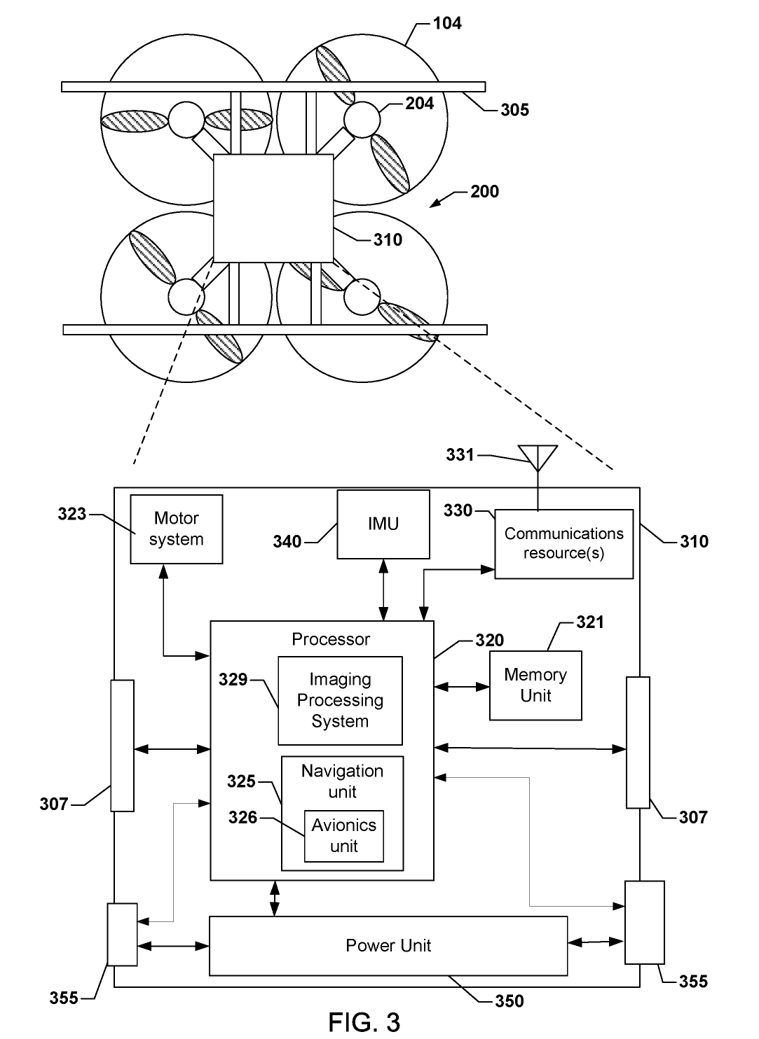

FIG. 3 illustrates components of an example drone 200 for use with various embodiments. With reference to FIGS. 1A-3, the illustrated drone 200 (which may be an example of the drone 200) is a “quadcopter” having four horizontally configured rotary lift propellers, or rotors 204 and motors 204 fixed to a frame 305. The frame 305 may support a control unit 310, the propeller assembly 100, power source (power unit 350) (e.g., battery), payload securing mechanism (payload securing unit 307), and other components. The rotors 104 may be driven by corresponding motors 204 to provide lift-off (or take-off) as well as other aerial movements (e.g., forward progression, ascension, descending, lateral movements, tilting, rotating, etc.). The drone 200 is illustrated as an example of a drone that may utilize various embodiments, but is not intended to imply or require that various embodiments are limited to rotorcraft drones. Instead, various embodiments may be used with winged drones as well. A drone may be propelled for flight in any of a number of known ways. For example, a plurality of propulsion units, each including one or more rotors, may provide propulsion or lifting forces for the drone. The drone may be powered by one or more types of power source, such as electrical, chemical, electro-chemical, or other power reserve, which may power the propulsion units, the onboard computing device, and/or other onboard components.

The drone 200 may be provided with a control unit 310. The control unit 310 may include a processor 320, one or more communication resources 330, an IMU 340, and a power unit 350. The processor 320 may be coupled to a memory unit 321 and a navigation unit 325. The processor 320 may be configured with processor-executable instructions to control flight and other operations of the drone 200, including operations of various embodiments. In some embodiments, the processor 320 may be coupled to a payload securing unit 307 and landing unit 355. The processor 320 may be powered from the power unit 350, such as a battery.

The processor 320 may be coupled to a motor system 323 that may be configured to manage the motors 204 that drive the rotors 104. The motor system 323 may include one or more propeller drivers. Each of the propeller drivers may include a motor 204, a motor shaft (not shown), and a propeller or rotor 104.

Through control of the individual motors 204 of the rotors 104, the drone 200 may be controlled in flight. In the processor 320, a navigation unit 325 may collect data and determine the present position and orientation of the drone 200, the appropriate course towards a destination, etc.

A camera apparatus 120 coupled to the drone 200 may provide image data from two (or more) cameras 210a, 210b to an image processing system 329 within or coupled to the processor 320. The image processing system 329 may be a separate image processor, such as an application specific integrated circuit (ASIC) or DSP, configured for processing images, such as stitching together images from the two (or more) cameras 210a, 210b to produce 360-degree images. Alternatively, the image processing system 329 may be implemented in software executing within the processor 320. Each of the cameras 210a, 210b may include sub-components other than image or video capturing sensors, including auto-focusing circuitry, International Organization for Standardization (ISO) adjustment circuitry, and shutter speed adjustment circuitry, etc.

The control unit 310 may include one or more communication resources 330, which may be coupled to an antenna 331 and include one or more transceivers. The transceiver(s) may include any of modulators, de-modulators, encoders, decoders, encryption modules, decryption modules, amplifiers, and filters. The communication resource(s) 330 may be capable of device-to-device communication with other drones, wireless communication devices carried by a user (e.g., a smartphone), a drone controller, ground stations such as mobile telephony network base stations, and other devices or electronic systems.

In some embodiments, the communication resource(s) 330 may include a Global Navigation Satellite System (GNSS) receiver (e.g., a Global Position System (GPS) receiver) configured to provide position information to the navigation unit 325. A GNSS receiver may provide three-dimensional coordinate information to the drone 200 by processing signals received from three or more GNSS satellites. In some embodiments, the navigation unit 325 may use an additional or alternate source of positioning signals other than GNSS or GPS. For example, the navigation unit 325 may receive information from processed images obtained by one or more of the cameras 210a, 210b to determine speed and direction of travel and attitude information by processing images of the ground.

An avionics component 326 of the navigation unit 325 may be configured to provide flight control-related information, such as altitude, attitude, airspeed, heading and similar information that may be used for navigation purposes. The avionics component 326 may also provide data regarding the orientation and accelerations of the drone 200 that may be used in navigation calculations.

The navigation unit 325 may include or be coupled to an inertial measurement unit (IMU) 340 configured to supply data to the navigation unit 325 and/or the avionics component 326. For example, the IMU 340 may include inertial sensors, such as one or more accelerometers (providing motion sensing readings), one or more gyroscopes (providing rotation sensing readings), one or more magnetometers (providing direction sensing), or any combination thereof. An IMU 340 may also include barometers, thermometers, audio sensors, motion sensors, etc. The IMU 340 may provide information regarding accelerations and orientation (e.g., with respect to the gravity gradient and earth's magnetic field) to enable the navigation unit 325 to perform navigational calculations, e.g., via dead reckoning, including at least one of the position, orientation (i.e., pitch, roll, and/or yaw), and velocity (e.g., direction and speed of movement) of the drone 200. A barometer may provide ambient pressure readings used to approximate elevation level (e.g., absolute elevation level) of the drone 200.

The one or more communication resources 330 may be configured to receive signals via the antenna 331 from a ground controller or ground based source of information and provide commands/data to the processor and/or the navigation unit to assist in operation of the drone 200. In some embodiments, commands for operating the motor system 323 may be received via the one or more communication resources 330.

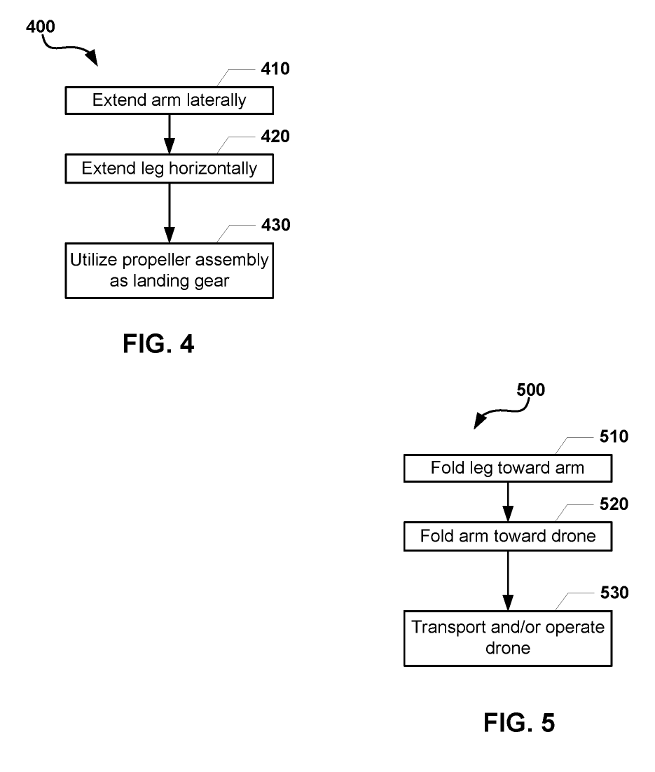

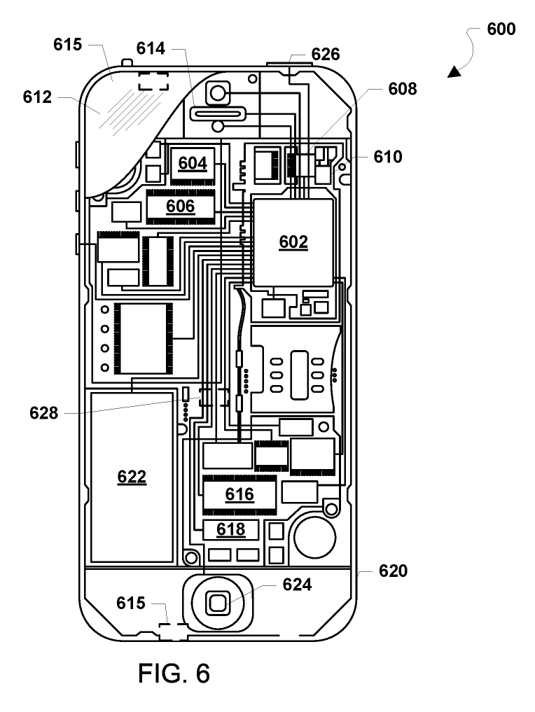

FIG. 4 illustrates a method 400 of operating a propeller assembly (e.g., 323 in FIGS. 1A-3) that may be extended and utilized as landing gear for a drone according to various embodiments. With reference to FIGS. 1A-4, operations of the method 400 may be performed by a UAV control unit 310 or another computing device (e.g., a wireless communication device 600 in FIG. 6) in communication with the UAV 200.

In block 410, the processor of the UAV (e.g., the processor 320 in the control unit 310 or processor in a remote device, such as the wireless communication device 600) may control the propeller assembly 323 to extend the pivotal arm 102 from the UAV body. In block 420, the processor of the UAV may control the propeller assembly 323 to extend the pivotal leg 106 from the pivotal arm 102. In block 430, the processor of the UAV may control the UAV 200 in such a manner that the UAV 200 utilizes the pivotal leg 106 on the pivotal arm 102 as landing gear (e.g., UAV 200 is landed).

FIG. 5 illustrates a method 500 of operating a pivotal leg 106 on a pivotal arm 102 that may be folded or otherwise collapsed into a UAV for transport and/or operation according to various embodiments. With reference to FIGS. 1A-5, operations of the method 500 may be performed by a UAV control unit 310 or another computing device (e.g., wireless communication device 600 in FIG. 6) in communication with the UAV 200.

In block 510, the processor of the UAV (e.g., the processor 320 in the control unit 310 or processor in a remote device, such as a wireless communication device 600) may control the pivotal leg 106 and the pivotal arm 102 to fold or otherwise retract the pivotal leg 106 towards the pivotal arm 102. In block 520, the processor of the UAV may control the pivotal leg 106 and the pivotal arm 102 to fold the pivotal arm 102 towards the UAV. In block 530, the processor of the UAV may control the UAV 200 for operation (e.g., flying) or the UAV 200 may be transported.

As described, the processor utilized to control operation of the pivotal leg 106 and the pivotal arm 102 may be in a separate computing device that is in communication with the UAV. In such embodiments, communications with the UAV (e.g., 200) may be implemented using any of a variety of wireless communication devices (e.g., smartphones, tablets, smartwatches, etc.) an example of which is illustrated in FIG. 6. The wireless communication device 600 may include a processor 602 coupled with the various systems of the wireless communication device 600 for communication with and control thereof. For example, the processor 602 may be coupled to a touch screen controller 604, radio communication elements, speakers and microphones, and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. In another embodiment (not shown), the wireless communication device 600 may also be coupled to an external memory, such as an external hard drive.

The touch screen controller 604 and the processor 602 may also be coupled to a touch screen panel 612, such as a resistive-sensing touch screen, capacitive-sensing touch screen, infrared sensing touch screen, etc. Additionally, the display of the wireless communication device 600 need not have touch screen capability. The wireless communication device 600 may have one or more radio signal transceivers 608 (e.g., Peanut, Bluetooth, Bluetooth LE, ZigBee, Wi-Fi®, radio frequency (RF) radio, etc.) and antennae, the wireless communication device antenna 610, for sending and receiving communications, coupled to each other and/or to the processor 602. The radio signal transceivers 608 and the wireless communication device antenna 610 may be used with the above-mentioned circuitry to implement the various wireless transmission protocol stacks and interfaces. The wireless communication device 600 may include a cellular network wireless modem chip 616 coupled to the processor that enables communication via a cellular network.

The wireless communication device 600 may include a peripheral device connection interface 618 coupled to the processor 602. The peripheral device connection interface 618 may be singularly configured to accept one type of connection, or may be configured to accept various types of physical and communication connections, common or proprietary, such as USB, FireWire, Thunderbolt, or PCIe. The peripheral device connection interface 618 may also be coupled to a similarly configured peripheral device connection port (not shown).

In various embodiments, the wireless communication device 600 may include one or more microphones 615. For example, the wireless communication device may have microphones 615 that may be conventional for receiving voice or other audio frequency energy from a user during a call.

The wireless communication device 600 may also include speakers 614 for providing audio outputs. The wireless communication device 600 may also include a housing 620, constructed of a plastic, metal, or a combination of materials, for containing all or some of the components discussed herein. The wireless communication device 600 may include a power source 622 coupled to the processor 602, such as a disposable or rechargeable battery. The rechargeable battery may also be coupled to the peripheral device connection port to receive a charging current from a source external to the wireless communication device 600. The wireless communication device 600 may also include a physical button 624 for receiving user inputs. The wireless communication device 600 may also include a power button 626 for turning the wireless communication device 600 on and off.

In various embodiments, the wireless communication device 600 may further include an accelerometer 628, which senses movement, vibration, and other aspects of the device through the ability to detect multi-directional values of and changes in acceleration. In the various embodiments, the accelerometer 628 may be used to determine the x, y, and z positions of the wireless communication device 600. Using the information from the accelerometer, a pointing direction of the wireless communication device 600 may be detected.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A propeller assembly for use on a drone, comprising:
a pivotal arm configured to be coupled to a body of the drone and configured to pivot between a first arm position extending from the body of the drone and a second arm position;
a propeller mounted near a distal end of the pivotal arm; and
a pivotal leg coupled to the pivotal arm and configured to pivot between a first leg position extending from the pivotal arm and a second leg position in which the pivotal leg is adjacent to the pivotal arm in a compact configuration.

2. The propeller assembly of claim 1, wherein:
the pivotal arm has a hollow portion exposed on at least one side of the pivotal arm; and
the pivotal leg is configured to fold into the hollow portion of the pivotal arm when the pivotal leg is in the second leg position.

3. The propeller assembly of claim 1, wherein:
the pivotal leg has a hollow portion exposed on at least one side of the pivotal leg; and
the pivotal leg is configured so that the hollow portion of the pivotal leg surrounds a portion of the pivotal arm when the pivotal leg is in the second leg position.

4. The propeller assembly of claim 1, wherein:
the pivotal arm has a hollow portion with an opening at the distal end of the pivotal arm; and
the pivotal leg is coupled to the pivotal arm and configured such that the pivotal leg is retractable into the hollow portion of the pivotal arm via the opening at the distal end of the pivotal arm when the pivotal leg is in the second leg position.

5. The propeller assembly of claim 1, further comprising a hinge coupled to the pivotal arm and the pivotal leg, wherein:
the hinge comprises a mechanism configured to pivot the pivotal leg between the first leg position and the second leg position.

6. The propeller assembly of claim 1, wherein the second arm position comprises the pivotal arm resting within an open volume of the body of the drone.

7. The propeller assembly of claim 1, wherein:
the pivotal arm has a hollow portion exposed on at least one side of the pivotal arm; and
a portion of the body of the drone is within the hollow portion of the pivotal arm when the pivotal arm is in the second arm position.

8. The propeller assembly of claim 1, wherein the pivotal leg is coupled to the distal end of the pivotal arm.

9. A propeller assembly for use on a drone, comprising:
an arm coupled to a body of the drone;
a propeller mounted near a distal end of the arm;
a leg coupled to the arm;
means for pivoting the arm between a first arm position extending from the body of the drone and a second arm position; and
means for pivoting the leg between a first leg position extending from the arm and a second leg position in which the leg is adjacent to the arm in a compact configuration.

10. The propeller assembly of claim 9, wherein:
the arm has a hollow portion exposed on at least one side of the arm; and
the means for pivoting the leg between the first leg position and the second leg position comprises means for folding the leg into the hollow portion of the arm.

11. The propeller assembly of claim 9, wherein:
the leg has a hollow portion exposed on at least one side of the leg; and
the means for pivoting the leg between the first leg position and the second leg position comprises means for folding the leg onto the arm such that the hollow portion of the leg surrounds a portion of the arm when the leg is in the second leg position.

12. The propeller assembly of claim 9, wherein:
the arm has a hollow portion with an opening at the distal end of the arm; and
the means for pivoting the leg between the first leg position and the second leg position comprises means for retracting the leg into the hollow portion of the arm via the opening at the distal end of the arm.

13. The propeller assembly of claim 9, wherein the means for pivoting the leg between the first leg position and the second leg position comprises means to pivot the leg between the first leg position and the second leg position.

14. The propeller assembly of claim 9, wherein:
the arm has a hollow portion exposed on at least one side of the arm; and
the means for pivoting the arm between the first arm position and the second arm position comprises means for folding the arm onto the body of the drone such that a portion of the body of the drone rests within the hollow portion of the arm.

15. The propeller assembly of claim 9, wherein the means for pivoting the arm between the first arm position and the second arm position comprises means for folding the arm into an open volume of the body of the drone.

16. A drone, comprising:
a body; and
a propeller assembly, comprising:
a pivotal arm configured to be coupled to the body and configured to pivot between a first arm position extending from the body of the drone and a second arm position;
a propeller mounted near a distal end of the pivotal arm; and
a pivotal leg coupled to the pivotal arm and configured to pivot between a first leg position extending from the pivotal arm and a second leg position in which the pivotal leg is adjacent to the pivotal arm in a compact configuration.

17. The drone of claim 16, wherein:
the pivotal arm has a hollow portion exposed on at least one side of the pivotal arm; and
the pivotal leg is configured to fold into the hollow portion of the pivotal arm when the pivotal leg is in the second leg position.

18. The drone of claim 16, wherein:
the pivotal leg has a hollow portion exposed on at least one side of the pivotal leg; and
the pivotal leg is configured so that the hollow portion of the pivotal leg surrounds a portion of the pivotal arm when the pivotal leg is in the second leg position.

19. The drone of claim 16, wherein:
the pivotal arm has a hollow portion with an opening at the distal end of the pivotal arm; and
the pivotal leg is coupled to the pivotal arm and configured such that the pivotal leg is retractable into the hollow portion of the pivotal arm via the opening at the distal end of the pivotal arm when the pivotal leg is in the second leg position.

20. The drone of claim 16, wherein:
the propeller assembly further comprises a hinge coupled to the pivotal arm and the pivotal leg; and
the hinge comprises a mechanism configured to pivot the pivotal leg between the first leg position and the second leg position.

21. The drone of claim 16, wherein:
the body has a hollow portion forming an open volume of the body; and
the second arm position comprises the pivotal arm resting within the open volume of the body.

22. The drone of claim 16, wherein:
the pivotal arm has a hollow portion exposed on at least one side of the pivotal arm; and
a portion of the body is within the hollow portion of the pivotal arm when the pivotal arm is in the second arm position.

23. The drone of claim 16, wherein the pivotal leg is coupled to the distal end of the pivotal arm.

24. A drone, comprising:
a body; and
a propeller assembly, comprising:
an arm coupled to the body;
a propeller mounted near a distal end of the arm;
a leg coupled to the arm;
means for pivoting the arm between a first arm position extending from the body of the drone and a second arm position; and
means for pivoting the leg between a first leg position extending from the arm and a second leg position in which the leg is adjacent to the arm in a compact configuration.

25. The drone of claim 24, wherein:
the arm has a hollow portion exposed on at least one side of the arm; and
the means for pivoting the leg between the first leg position and the second leg position comprises means for folding the leg into the hollow portion of the arm.

26. The drone of claim 24, wherein:
the leg has a hollow portion exposed on at least one side of the leg; and
the means for pivoting the leg between the first leg position and the second leg position comprises means for folding the leg onto the arm such that the hollow portion of the leg surrounds a portion of the arm when the leg is in the second leg position.

27. The drone of claim 24, wherein:
the arm has a hollow portion with an opening at the distal end of the arm; and
the means for pivoting the leg between the first leg position and the second leg position comprises means for retracting the leg into the hollow portion of the arm via the opening at the distal end of the arm.

28. The drone of claim 24, wherein the means for pivoting the leg between the first leg position and the second leg position comprises means to pivot the leg between the first leg position and the second leg position.

29. The drone of claim 24, wherein:
the body has a hollow portion; and
the means for pivoting the arm between the first arm position and the second arm position comprises means for folding the arm into the hollow portion of the body.

30. The drone of claim 24, wherein:
the arm has a hollow portion exposed on at least one side of the arm; and
the means for pivoting the arm between the first arm position and the second arm position comprises means for folding the arm onto the body of the drone such that a portion of the body of the drone rests within the hollow portion of the arm.
